(19) United States
(12) Patent Application Publication
(10) Pub. No.: US 2014/0160417 A1
(43) Pub. Date: Jun. 12, 2014

(54) LIQUID CRYSTAL DISPLAY DEVICE

(71) Applicant: Japan Display Inc., Minato-ku (JP)

(72) Inventors: Yusuke MORITA, Tokyo (JP); Jin HIROSAWA, Tokyo (JP); Hirokazu MORIMOTO, Tokyo (JP); Arihiro TAKEDA, Tokyo (JP)

(73) Assignee: Japan Display Inc., Minato-ku (JP)

(21) Appl. No.: 14/097,846

(22) Filed: Dec. 5, 2013

(30) Foreign Application Priority Data
Dec. 12, 2012 (JP) 2012-271136

(51) Int. Cl. G02F 1/1343

(52) U.S. Cl. CPC G02F 1/13439
USPC 349/139

(57) ABSTRACT

According to one embodiment, a liquid crystal display device includes a first substrate including a pixel electrode including a contact portion and a main pixel electrode extending in a second direction from the contact portion. A width of the contact portion in a first direction crossing the second direction is greater than a width of the main pixel electrode in the first direction. The main pixel electrode includes a first portion which is located on a side close to the contact portion and has a first width in the first direction, and a second portion which is located on a side remoter from the contact portion than the first portion in the second direction and has a second width in the first direction which is smaller than the first width.

### CROSS-REFERENCE TO RELATED APPLICATIONS

This application is based upon and claims the benefit of priority from Japanese Patent Application No. 2012-271136, filed Dec. 12, 2012, the entire contents of which are incorporated herein by reference.

### FIELD

Embodiments described herein relate generally to a liquid crystal display device.

### BACKGROUND

In recent years, in active matrix liquid crystal display devices in which switching elements are incorporated in respective pixels, configurations, which make use of a lateral electric field (including a fringe electric field), such as an IPS (In-Plane Switching) mode or an FFS (Fringe Field Switching) mode, have been put to practical use. Such a liquid crystal display device of the lateral electric field mode includes pixel electrodes and a counter-electrode, which are formed on an array substrate, and liquid crystal molecules are switched by a lateral electric field which is substantially parallel to a major surface of the array substrate. In connection with the lateral electric field mode, there has been proposed a technique wherein a lateral electric field or an oblique electric field is produced between a pixel electrode formed on an array substrate and a counter-electrode formed on a counter-substrate, thereby switching liquid crystal molecules.

### BRIEF DESCRIPTION OF THE DRAWINGS

FIG. 1 is a view which schematically illustrates a structure and an equivalent circuit of a liquid crystal display device according to an embodiment.

FIG. 2 is a plan view which schematically shows a structure example of one pixel at a time when a liquid crystal display panel shown in FIG. 1 is viewed from a counter-substrate side.

FIG. 3 is a cross-sectional view, taken along line A-A in FIG. 2, which schematically shows a cross-sectional structure of the liquid crystal display panel shown in FIG. 2.

FIG. 4 is a plan view which schematically shows another structure example of one pixel at a time when the liquid crystal display panel shown in FIG. 1 is viewed from the counter-substrate side.

FIG. 5 is a plan view which schematically shows another structure example of one pixel at a time when the liquid crystal display panel shown in FIG. 1 is viewed from the counter-substrate side.

FIG. 6 is a plan view which schematically shows another structure example of one pixel at a time when the liquid crystal display panel shown in FIG. 1 is viewed from the counter-substrate side.

FIG. 7 is a plan view which schematically shows another structure example of one pixel at a time when the liquid crystal display panel shown in FIG. 1 is viewed from the counter-substrate side.

FIG. 8 is a plan view which schematically shows a structure example of one pixel at a time when the width of a main pixel electrode in a first direction is made uniform.

### DETAILED DESCRIPTION

In general, according to one embodiment, a liquid crystal display device includes: a first substrate including a pixel electrode including a contact portion and a main pixel electrode extending in a second direction from the contact portion; a second substrate including main common electrodes extending in the second direction on both sides of the main pixel electrode; and a liquid crystal layer including liquid crystal molecules held between the first substrate and the second substrate, wherein a width of the contact portion in a first direction crossing the second direction is greater than a width of the main pixel electrode in the first direction, and the main pixel electrode includes a first portion which is located on a side close to the contact portion and has a first width in the first direction, and a second portion which is located on a side remoter from the contact portion than the first portion in the second direction and has a second width in the first direction which is smaller than the first width.

According to another embodiment, a liquid crystal display device includes: a first substrate including a pixel electrode including a contact portion and a main pixel electrode extending in a second direction from the contact portion; a second substrate including main common electrodes extending in the second direction on both sides of the main pixel electrode; and a liquid crystal layer including liquid crystal molecules held between the first substrate and the second substrate, wherein a width of the contact portion in a first direction crossing the second direction is greater than a width of the main pixel electrode in the first direction, and the main common electrode includes a third portion which is located on a side close to the contact portion and has a third width in the first direction, and a fourth portion which is located on a side remoter from the contact portion than the third portion in the second direction and has a fourth width in the first direction which is greater than the third width.

Embodiments will now be described in detail with reference to the accompanying drawings. In the drawings, structural elements having the same or similar functions are denoted by like reference numerals, and an overlapping description is omitted.

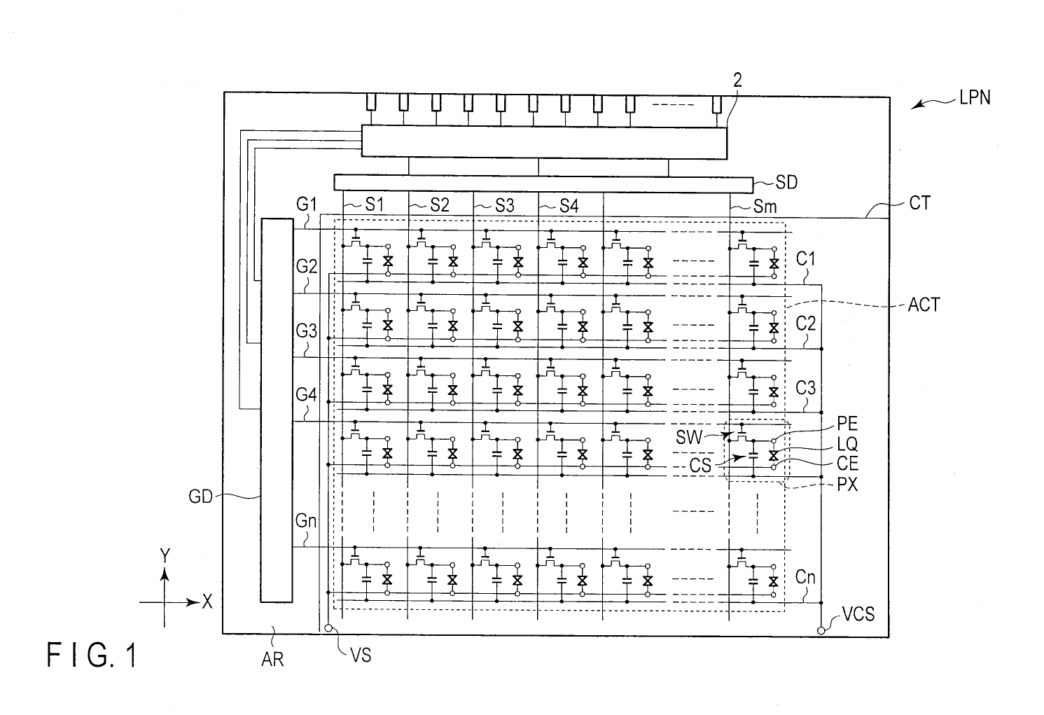

FIG. 1 is a view which schematically shows a structure and an equivalent circuit of a liquid crystal display device according to an embodiment.

Specifically, the liquid crystal display device includes an active-matrix-type liquid crystal display panel LPN. The liquid crystal display panel LPN includes an array substrate AR which is a first substrate, a counter-substrate CT which is a second substrate that is disposed to be opposed to the array substrate AR, and a liquid crystal layer LQ which is held between the array substrate AR and the counter-substrate CT. The liquid crystal display panel LPN includes an active area ACT which displays an image. The active area ACT is composed of a plurality of pixels PX which are arrayed in a matrix of m×n (m and n are positive integers).

The liquid crystal display panel LPN includes, in the active area ACT, an n-number of gate lines G (G1 to Gn), an n-number of storage capacitance lines C (C1 to Cn), and an m-number of source lines S (S1 to Sm). The gate lines G and storage capacitance lines extend, for example, substantially linearly in a first direction X. The gate lines G and storage capacitance lines C neighbor at intervals along a second direction Y crossing the first direction X, and are alternately arranged in parallel. In this example, the first direction X and the second direction Y are perpendicular to each other. The source lines S cross the gate lines G and storage capacitance lines C. The source lines S extend substantially linearly in the second direction Y. It is not always necessary that each of the gate lines G, storage capacitance lines C and source lines S extend linearly, and a part thereof may be bent.

Each of the gate lines G is led out of the active area ACT and is connected to a gate driver GD. Each of the source lines S is led out of the active area ACT and is connected to a source driver SD. At least parts of the gate driver GD and source driver SD are formed on, for example, the array substrate AR, and are connected to a driving IC chip 2 which incorporates a controller.

Each of the pixels PX includes a switching element SW, a pixel electrode PE and a common electrode CE. A storage capacitance CS is formed, for example, between the storage capacitance line C and the pixel electrode PE. The storage capacitance line C is electrically connected to a voltage application module VCS to which a storage capacitance voltage is applied.

In the present embodiment, the liquid crystal display panel LPN is configured such that the pixel electrodes PE are formed on the array substrate AR, and at least a part of the common electrode CE is formed on the counter-substrate CT, and liquid crystal molecules of the liquid crystal layer LQ are switched by mainly using an electric field which is produced between the pixel electrodes PE and the common electrode CE. The electric field, which is produced between the pixel electrodes PE and the common electrode CE, is an oblique electric field which is slightly inclined to an X-Y plane or a substrate major surface which is defined by the first direction X and second direction Y (or a lateral electric field which is substantially parallel to the substrate major surface).

The switching element SW is composed of, for example, an n-channel thin-film transistor (TFT). The switching element SW is electrically connected to the gate line G and source line S. The switching element SW may be of a top gate type or a bottom gate type. In addition, a semiconductor layer of the switching element SW is formed of, for example, polysilicon, but it may be formed of amorphous silicon.

The pixel electrodes PE are disposed in the respective pixels PX, and are electrically connected to the switching elements SW. The common electrode CE has, for example, a common potential, and is disposed common to the pixel electrodes PE of plural pixels PX via the liquid crystal layer LQ. The pixel electrodes PE and common electrode CE are formed of, for example, a light-transmissive, electrically conductive material such as indium tin oxide (ITO) or indium zinc oxide (IZO), but may be formed of other metallic material such as aluminum.

The array substrate AR includes a power supply module VS for applying a voltage to the common electrode CE. The power supply module VS is formed, for example, on the outside of the active area ACT. The common electrode CE is led out to the outside of the active area ACT, and is electrically connected to the power supply module VS via an electrically conductive member (not shown).

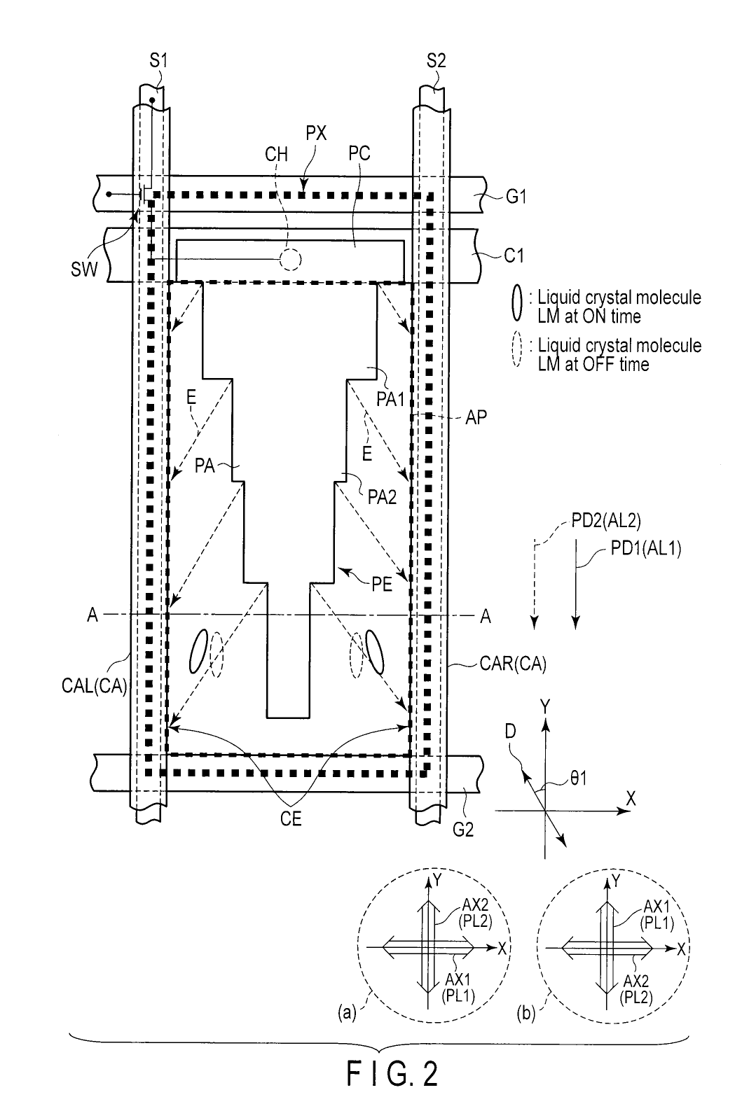

FIG. 2 is a plan view which schematically shows a structure example of one pixel PX at a time when the liquid crystal display panel LPN shown in FIG. 1 is viewed from the counter-substrate side. FIG. 2 is a plan view in an X-Y plane.

The pixel PX illustrated has a rectangular shape having a less length in the first direction X than in the second direction Y, as indicated by a broken line. In the embodiment, the width in the first direction X of the pixel PX is about 40 μm. A gate line G1 and a gate line G2 extend in the first direction. A storage capacitance line C1 is disposed between the gate line G1 and gate line G2, and extends in the first direction X. A source line S1 and a source line S2 extend in the second direction Y. The pixel electrode PE is disposed between the neighboring source line S1 and source line S2. In addition, the pixel electrode PE is disposed between the gate line G1 and gate line G2.

In the example illustrated, in the pixel PX, the source line S1 is disposed at a left side end portion, and the source line S2 is disposed at a right side end portion. Strictly speaking, the source line S1 is disposed to extend over a boundary between the pixel PX and a pixel neighboring on the left side, and the source line S2 is disposed to extend over a boundary between the pixel PX and a pixel neighboring on the right side. In addition, in the pixel PX, the gate line G1 is disposed at an upper side end portion, and the gate line G2 is disposed at a lower side end portion. Strictly speaking, the gate line G1 is disposed to extend over a boundary between the pixel PX and a pixel neighboring on the upper side, and the gate line G2 is disposed to extend over a boundary between the pixel PX and a pixel neighboring on the lower side. The storage capacitance line C1 is disposed in the vicinity of the gate line G1.

The switching element SW, in the illustrated example, is electrically connected to the gate line G1 and source line S1. The switching element SW is provided near an intersection between the gate line G1 and source line S1, and a drain line of the switching element SW is formed to extend along the source line S1 and storage capacitance line C1 and is electrically connected to the pixel electrode PE via a contact hole CH which is formed in a region overlapping the storage capacitance line C1. The switching element SW is provided in a region where the source line S1 and storage capacitance line C1 overlap, and hardly protrudes from the region where the source line S1 and storage capacitance line C1 overlap, thereby suppressing a decrease in area of an aperture region AP which contributes to display. In the meantime, the aperture region AP is a region surrounded by a wiring (first wiring) extending in the first direction X and a wiring (second wiring) extending in the second direction Y. In the example illustrated in FIG. 2, the aperture region AP is a region surrounded by the source line S1, source line S2, storage capacitance line C1 and gate line G2.

The pixel electrode PE includes a main pixel electrode PA and a contact portion PC, which are electrically connected to each other.

The main pixel electrode PA extends in the second direction Y from the contact portion PC to the vicinity of the upper side end portion of the pixel PX and to the vicinity of the lower side end portion of the pixel PX. The width in the first direction X of the main pixel electrode PA is large at a portion thereof near the contact portion PC, and gradually decreases away from the contact portion PC. In the example illustrated, the width of the main pixel electrode PA varies stepwise. The shape of the main pixel electrode PA is line-symmetric with respect to an axis which is substantially parallel to the second direction Y. Each of both end portions in the first direction X of the main pixel electrode PA, that is, each of an end portion on the source line S1 side and an end portion on the source line S2 side, has at least one step. Specifically, the main pixel electrode PA is surrounded by two stepwise end sides (i.e. an end side facing the source line S1 and an end side facing the source line S2) and a boundary line with the contact portion PC. In the meantime, it is desirable that the main pixel electrode PA have at least one step at a central portion thereof in the second direction Y (or at a central portion of the aperture region AP). In addition, in the case where each of both end portions of the main pixel electrode PA includes a plurality of steps, it is desirable that these plural steps be arranged with predetermined distances.

In other words, in a direction along the first direction X, the main pixel electrode PA has a larger width at a portion thereof which is continuous with the contact portion PC, than at a distal end portion thereof extending in the second direction Y (i.e. an end portion near the gate line G2). In addition, the main pixel electrode PA includes a first portion PA1 which is located on a side close to the contact portion PC, and a second portion PA2 which is located on a side remoter from the contact portion PC in the second direction Y than the first portion PA1. When the width in the first direction X of the first portion PA1 is WA and the width in the first direction X of the second portion PA2 is WB, it should suffice if the width WA>the width WB. The width in the first direction X of the main pixel electrode PA may vary stepwise in the second direction Y, or may vary continuously in the second direction Y.

The contact portion PC is located on a region overlapping the storage capacitance line C1, and is electrically connected to the switching element SW via the contact hole CH. The width in the first direction X of the contact portion PC is greater than the maximum value of the width in the first direction X of the main pixel electrode PA.

The pixel electrode PE is disposed at a substantially middle position between the source line S1 and source line S2, that is, at the center of the pixel PX. At each of positions along the second direction Y, the distance in the first direction X between the source line S1 and the pixel electrode PE is substantially equal to the distance in the first direction X between the source line S2 and the pixel electrode PE.

The common electrode CE includes main common electrodes CA. The main common electrodes CA, in the X-Y plane, are located on both sides of the main pixel electrode PA, and linearly extend in the second direction Y which is substantially parallel to the main pixel electrode PA. Alternatively, the main common electrodes CA are opposed to the respective source lines S, and extend substantially in parallel to the main pixel electrode PA. The main common electrode CA is formed in a strip shape having a substantially uniform width in the first direction X.

In the example illustrated, two main common electrodes CA are arranged in parallel along the first direction X, and are disposed at both left and right end portions of the pixel PX. In the description below, in order to distinguish these main common electrodes CA, the main common electrode on the left side in the Figure is referred to as “CAL”, and the main common electrode on the right side in the Figure is referred to as “CAR”. The main common electrode CAL is opposed to the source line S1, and the main common electrode CAR is opposed to the source line S2. The main common electrode CAL and the main common electrode CAR are electrically connected to each other within the active area or outside the active area.

In the pixel PX, the main common electrode CAL is disposed at the left side end portion, and the main common electrode CAR is disposed at the right side end portion. Strictly speaking, the main common electrode CAL is disposed to extend over a boundary between the pixel PX and a pixel neighboring on the left side, and the main common electrode CAR is disposed to extend over a boundary between the pixel PX and a pixel neighboring on the right side.

Paying attention to the positional relationship between the pixel electrode PE and the main common electrodes CA, the pixel electrode PE and the main common electrodes CA are alternately arranged in the first direction X. The pixel electrode PE and the main common electrodes CA are arranged substantially in parallel to each other. In this case, in the X-Y plane, neither of the main common electrodes CA overlaps the pixel electrode PE.

Specifically, one pixel electrode PE is located between the neighboring main common electrode CAL and main common electrode CAR. In other words, the main common electrode CAL and main common electrode CAR are disposed on both sides of a position immediately above the pixel electrode PE. Alternatively, the pixel electrode PE is disposed between the main common electrode CAL and main common electrode CAR. Thus, the main common electrode CAL, main pixel electrode PA and main common electrode CAR are arranged in the named order along the first direction X.

The distance in the first direction X between the main common electrode CAL and the first portion PA1 of the main pixel electrode PA is substantially equal to the distance in the first direction X between the main common electrode CAR and the first portion PA1 of the main pixel electrode PA. In addition, the distance in the first direction X between the main common electrode CAL and the second portion PA2 of the main pixel electrode PA is substantially equal to the distance in the first direction X between the main common electrode CAR and the second portion PA2 of the main pixel electrode PA. It should be noted, however, that the distance between the first portion PA1 and each of the main common electrode CAR and main common electrode CAL less than the distance between the first portion PA2 and each of the main common electrode CAR and main common electrode CAL.

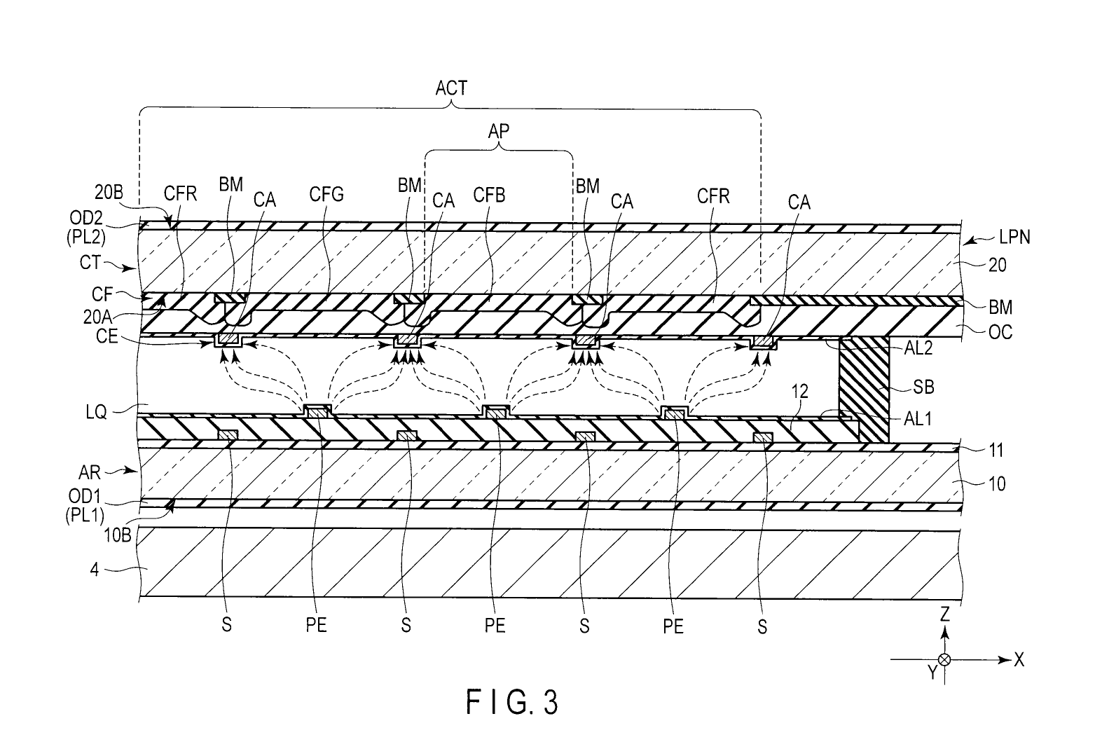

FIG. 3 is a cross-sectional view, taken along line A-A in FIG. 2, which schematically shows a cross-sectional structure of the liquid crystal display panel LPN shown in FIG. 2. FIG. 3 shows only parts which are necessary for the description. In addition, a third direction Z is a direction perpendicular to the first direction X and second direction Y, or a normal direction to the liquid crystal display panel LPN.

A backlight 4 is disposed on the back side of the array substrate AR which constitutes the liquid crystal display panel LPN. Various modes are applicable to the backlight 4. As the backlight 4, use may be made of either a backlight which utilizes a light-emitting diode (LED) as a light source, or a backlight which utilizes a cold cathode fluorescent lamp (CCFL) as a light source. A description of the detailed structure of the backlight 4 is omitted.

The array substrate AR is formed by using a first insulative substrate 10 having light transmissivity. Source lines S are formed on a first interlayer insulation film 11, and are covered with a second interlayer insulation film 12. In the meantime, gate lines and storage capacitance lines, which are not shown, are disposed, for example, between the first insulative substrate 10 and the first interlayer insulation film 11. Pixel electrodes PE are formed on the second interlayer insulation film 12. The pixel electrode PE is located on the inside of positions immediate above neighboring source lines S.

A first alignment film AL1 is disposed on that surface of the array substrate AR, which is opposed to the counter-substrate CT, and the first alignment film AL1 extends over substantially the entirety of the active area ACT. The first alignment film AL1 covers the pixel electrode PE, etc., and is also disposed on the second interlayer insulation film 12. The first alignment film AL1 is formed of a material which exhibits horizontal alignment properties, and is coated with a thickness of about 70 nm.

The array substrate AR may further include a part of a common electrode CE.

The counter-substrate CT is formed by using a second insulative substrate 20 having light transmissivity. The counter-substrate CT includes a black matrix BM, a color filter CF, an overcoat layer OC, a common electrode CE and a second alignment film AL2.

The black matrix BM partitions each pixel PX and forms an aperture region AP which is opposed to the pixel electrode PE. Specifically, the black matrix BM is disposed so as to be opposed to wiring portions, such as the source lines S, gate lines, storage capacitance lines and switching elements. In this example, only those portions of the black matrix BM, which extend in the second direction Y, are illustrated, but the black matrix BM may include portions extending in the first direction X. The black matrix BM is disposed on an inner surface 20A of the second insulative substrate 20, which is opposed to the array substrate AR.

The color filter CF is disposed in association with each pixel PX. Specifically, the color filter CF is disposed in the aperture region AP on the inner surface 20A of the second insulative substrate 20, and a part of the color filter CF extends over the black matrix BM. Color filters CF, which are disposed in the pixels PX neighboring in the first direction X, have mutually different colors. For example, the color filters CF are formed of resin materials which are colored in three primary colors of red, blue and green. A red color filter CFR, which is formed of a resin material that is colored in red, is disposed in association with a red pixel. A blue color filter CFB, which is formed of a resin material that is colored in blue, is disposed in association with a blue pixel. A green color filter CFG, which is formed of a resin material that is colored in green, is disposed in association with a green pixel. Boundaries between these color filters CF are located at positions overlapping the black matrix BM.

The overcoat layer OC covers the color filters CF. The overcoat layer OC reduces the effect of asperities on the surface of the color filters CF.

The common electrode CE is formed on that side of the overcoat layer OC, which is opposed to the array substrate AR.

The second alignment film AL2 is disposed on that surface of the counter-substrate CT, which is opposed to the array substrate AR, and the second alignment film AL2 extends over substantially the entirety of the active area ACT. The second alignment film AL2 covers the common electrode CE and the overcoat layer OC. The second alignment film AL2 is formed of a material which exhibits horizontal alignment properties, and is coated with a thickness of about 70 nm.

The first alignment film AL1 and second alignment film AL2 are subjected to alignment treatment (e.g. rubbing treatment or optical alignment treatment) for initially aligning the liquid crystal molecules of the liquid crystal layer LQ. A first alignment treatment direction PD1, in which the first alignment film AL1 initially aligns the liquid crystal molecules, and a second alignment treatment direction PD2, in which the second alignment film AL2 initially aligns the liquid crystal molecules, are parallel to each other, and are opposite or identical to each other. For example, as shown in FIG. 2, the first alignment treatment direction PD1 and the second alignment treatment direction PD2 are substantially parallel to the second direction Y and are identical to each other.

The above-described array substrate AR and counter-substrate CT are disposed such that their first alignment film AL1 and second alignment film AL2 are opposed to each other. In this case, columnar spacers, which are formed of, e.g. a resin material so as to be integral to one of the array substrate AR and counter-substrate CT, are disposed between the first alignment film AL1 of the array substrate AR and the second alignment film AL2 of the counter-substrate CT. Thereby, a predetermined cell gap, for example, a cell gap of 2 to 7 μm, is created. The array substrate AR and counter-substrate CT are attached by a sealant SB on the outside of the active area ACT in the state in which the predetermined cell gap is created therebetween. In this embodiment, the cell gap is about 4 μm.

The liquid crystal layer LQ is held in the cell gap which is created between the array substrate AR and the counter-substrate CT, and is disposed between the first alignment film AL1 and second alignment film AL2. The liquid crystal layer LQ is composed of, for example, a liquid crystal material having a positive (positive-type) dielectric constant anisotropy.

A first optical element OD1 is attached by, e.g. an adhesive to an outer surface of the array substrate AR, that is, an outer surface 10B of the first insulative substrate 10. The first optical element OD1 is located on that side of the liquid crystal display panel LPN, which is opposed to the backlight 4, and controls the polarization state of incident light which enters the liquid crystal display panel LPN from the backlight 4. The first optical element OD1 includes a first polarizer PL1 having a first polarization axis AX1.

A second optical element OD2 is attached by, e.g. an adhesive to an outer surface of the counter-substrate CT, that is, an outer surface 20B of the second insulative substrate 20. The second optical element OD2 is located on the display surface side of the liquid crystal display panel LPN, and controls the polarization state of emission light emerging from the liquid crystal display panel LPN. The second optical element OD2 includes a second polarizer PL2 having a second polarization axis AX2.

The first polarization axis AX1 of the first polarizer PL1 and the second polarization axis AX2 of the second polarizer PL2 have, for example, a substantially orthogonal positional relationship (crossed Nicols). In this case, one of the polarizers is disposed, for example, such that the polarization axis thereof is substantially parallel or substantially perpendicular to the direction of the initial alignment direction of liquid crystal molecules. When the initial alignment direction is parallel to the second direction Y, the polarization axis of one of the polarizers is parallel to the second direction Y, or is parallel to the first direction X.

In an example shown in part (a) of FIG. 2, the first polarizer PL1 is disposed such that the first polarization axis AX1 thereof is perpendicular to the second direction Y, and the second polarizer PL2 is disposed such that the second polarization axis AX2 thereof is parallel to the second direction Y. In an example shown in part (b) of FIG. 2, the second polarizer PL2 is disposed such that the second polarization axis AX2 thereof is perpendicular to the second direction Y, and the first polarizer PL1 is disposed such that the first polarization axis AX1 thereof is parallel to the second direction Y.

Next, the operation of the liquid crystal display panel LPN having the above-described structure is described with reference to FIG. 2 and FIG. 3.

Specifically, in a state in which no voltage is applied to the liquid crystal layer LQ, that is, in a state (OFF time) in which no potential difference (or electric field) is produced between the pixel electrode PE and common electrode CE, the liquid crystal molecule LM of the liquid crystal layer LQ is aligned such that the major axis thereof is positioned in the first alignment treatment direction PD1 and the second alignment treatment direction PD2. This OFF time corresponds to the initial alignment state, and the alignment direction of the liquid crystal molecule LM at the OFF time corresponds to the initial alignment direction.

Strictly speaking, the liquid crystal molecule LM is not always aligned in parallel to the X-Y plane, and, in many cases, the liquid crystal molecule LM is pre-tilted. Thus, the initial alignment direction of the liquid crystal molecule LM corresponds to a direction in which the major axis of the liquid crystal molecule LM at the OFF time is orthogonally projected onto the X-Y plane. In the description below, for the purpose of simple description, it is assumed that the liquid crystal molecule LM is aligned in parallel to the X-Y plane, and the liquid crystal molecule LM rotates in a plane parallel to the X-Y plane.

In this example, the first alignment treatment direction PD1 and the second alignment treatment direction PD2 are substantially parallel to the second direction Y. The liquid crystal molecule LM at the OFF time is initially aligned such that the major axis thereof is substantially parallel to the second direction Y in the X-Y plane, as indicated by a broken line in FIG. 2. In short, the initial alignment direction of the liquid crystal molecule LM is parallel to the second direction Y.

In the cross section of the liquid crystal layer LQ, the liquid crystal molecules LM are substantially horizontally aligned (the pre-tilt angle is substantially zero) in the middle part of the liquid crystal layer LQ, and the liquid crystal molecules LM are aligned with such pre-tilt angles that the liquid crystal molecules LM become symmetric in the vicinity of the first alignment film AL1 and in the vicinity of second alignment film AL2, with respect to the middle part as the boundary (splay alignment). In this case, when the first alignment treatment direction PD1 and the second alignment treatment direction PD2 are parallel and identical to each other, the liquid crystal molecules LM are splay-aligned, as described above, and the alignment of liquid crystal molecules LM in the vicinity of the first alignment film AL1 on the array substrate AR and the alignment of liquid crystal molecules LM in the vicinity of the second alignment film AL2 on the counter-substrate CT become vertically symmetric with respect to the middle part of the liquid crystal layer LQ as the boundary, as described above. Thus, optical compensation can be made even in a direction inclined to the normal direction (third direction Z) of the substrate. Therefore, light leakage is small in the case of black display, a high contrast ratio can be realized, and the display quality can be improved.

In the meantime, when the first alignment treatment direction PD1 and the second alignment treatment direction PD2 are parallel and opposite to each other, the liquid crystal molecules LM are aligned with substantially equal pre-tilt angles, in the cross section of the liquid crystal layer LQ, in the vicinity of the first alignment film AL1, in the vicinity of the second alignment film AL2, and in the middle part of the liquid crystal layer LQ (homogeneous alignment).

At this OFF time, part of light from the backlight 4 passes through the first polarizer PL1, and enters the liquid crystal display panel LPN. The light, which has entered the liquid crystal display panel LPN, is linearly polarized light which is perpendicular to the first polarization axis AX1 of the first polarizer PL1. The polarization state of linearly polarized light hardly varies when the light passes through the liquid crystal layer LQ at the OFF time. Thus, the linearly polarized light, which has passed through the liquid crystal display panel LPN, is absorbed by the second polarizer PL2 that is in the positional relationship of crossed Nicols in relation to the first polarizer PL1 (black display).

On the other hand, in a state in which a voltage is applied to the liquid crystal layer LQ, that is, in a state (ON time) in which a potential difference (or electric field) is produced between the pixel electrode PE and the common electrode CE, a lateral electric field (or an oblique electric field), which is substantially parallel to the substrates, is produced between the pixel electrode PE and the common electrode CE. The liquid crystal molecule LM is affected by the electric field, and the major axis thereof rotates in a plane which is substantially parallel to the X-Y plane, as indicated by a solid line in the Figure.

In the example shown in FIG. 2, the liquid crystal molecule LM in the region between the pixel electrode PE and main common electrode CAL rotates clockwise relative to the second direction Y, and is aligned in a lower left direction in the Figure. The liquid crystal molecule LM in the region between the pixel electrode PE and main common electrode CAR rotates counterclockwise relative to the second direction Y, and is aligned in a lower right direction in the Figure.

As has been described above, in the state in which the electric field is produced between the pixel electrode PE and common electrode CE in each pixel PX, the liquid crystal molecules LM are aligned in a plurality of directions, with boundaries at positions overlapping the pixel electrodes PE, and domains are formed in the respective alignment directions. Specifically, a plurality of domains are formed in one pixel PX.

At this ON time, part of light, which is incident on the liquid crystal display panel LPN from the backlight 4, passes through the first polarizer PL1 and enters the liquid crystal display panel LPN. The light, which has entered the liquid crystal display panel LPN, is linearly polarized light perpendicular to the first polarization axis AX1 of the first polarizer PL1. The polarization state of the linearly polarized light varies depending on the alignment state of the liquid crystal molecules LM when the light passes through the liquid crystal layer LQ. Thus, at this ON time, at least part of the light emerging from the liquid crystal layer LQ passes through the second polarizer PL2 (white display). However, at a position overlapping the pixel electrode or common electrode, since the liquid crystal molecules maintain the initial alignment state, black display is effected as in the case of the OFF time.

In the OFF state, the liquid crystal molecules LM are initially aligned in a direction which is substantially parallel to the second direction Y. In the ON state in which a potential difference is produced between the pixel electrode PE and the common electrode CE, when the director of the liquid crystal molecule LM (or the major-axis direction of the liquid crystal molecule LM) deviates by about 45° in the X-Y plane from the first polarization axis AX1 of the first polarizer PL1 and from the second polarization axis AX2 of the second polarizer PL2, the optical modulation ratio of the liquid crystal layer LQ is highest (i.e. the transmittance at the aperture region is highest).

In the example illustrated, in the ON state, the director of the liquid crystal molecule LM between the main common electrode CAL and the pixel electrode PE is substantially parallel to a 45°-225° azimuth direction in the X-Y plane, and the director of the liquid crystal molecule LM between the main common electrode CAR and the pixel electrode PE is substantially parallel to a 135°-315° azimuth direction in the X-Y plane, and a peak transmittance is obtained. At this time, if attention is paid to the transmittance distribution per pixel, while the transmittance is substantially zero over the pixel electrode PE and common electrode CE, a high transmittance can be obtained over almost the entire area of the inter-electrode gaps between the pixel electrode PE and the common electrode CE.

Each of the main common electrode CAL that is located immediately above the source line S1 and the main common electrode CAR that is located immediately above the source line S2 is opposed to the black matrix BM. Each of the main common electrode CAL and main common electrode CAR has a width which is equal to or less than the width of the black matrix BM in the first direction X, and does not extend toward the pixel electrode PE from the position overlapping the black matrix BM. Thus, the aperture region in each pixel, which contributes to display, corresponds to regions between the pixel electrode PE and main common electrode CAL and between the pixel electrode PE and main common electrode CAR, these regions being included in the region between the black matrixes BM or the region between the source line S1 and source line S2.

According to the present embodiment, a decrease in transmittance can be suppressed. Thereby, degradation in display quality can be suppressed.

In addition, according to the present embodiment, a high transmittance can be obtained in the inter-electrode gap between the pixel electrode PE and the common electrode CE. A transmittance per pixel can sufficiently be increased by increasing the inter-electrode distance between the main pixel electrode PA and the main common electrode CA. As regards product specifications in which the pixel pitch is different, the peak condition of the transmittance distribution can be used by varying the inter-electrode distance (for example, by changing the position of disposition of the main common electrode CA in relation to the main pixel electrode PA). Specifically, in the display mode of the present embodiment, products with various pixel pitches can be provided by setting the inter-electrode distance, without necessarily requiring fine electrode processing, as regards the product specifications from low-resolution product specifications with a relatively large pixel pitch to high-resolution product specifications with a relatively small pixel pitch. Therefore, requirements for high transmittance and high resolution can easily be realized.

According to the present embodiment, in the region overlapping the black matrix BM, the transmittance is sufficiently lowered. The reason for this is that the electric field does not leak to the outside of the pixel from the position of the common electrode CE, and an undesired lateral electric field does not occur between pixels which neighbor each other with the black matrix BM interposed, and therefore the liquid crystal molecules in the region overlapping the black matrix BM keep the initial alignment state, like the case of the OFF time (or black display time).

When misalignment occurs between the array substrate AR and the counter-substrate CT, there are cases in which a difference occurs in the horizontal inter-electrode distance (the distance in the first direction X) between the pixel electrode PE and the common electrodes CE on both sides of the pixel electrode PE. However, since such misalignment commonly occurs in all pixels PX, the electric field distribution does not differ between the pixels PX, and the influence on the display of images is very small. In addition, even when misalignment occurs between the array substrate AR and the counter-substrate CT, leakage of an undesired electric field to the neighboring pixel can be suppressed. Thus, even when the colors of the color filters differ between neighboring pixels, the occurrence of color mixture can be suppressed, and the decrease in color reproducibility or the decrease in contrast ratio can be suppressed.

According to the present embodiment, the main common electrodes CA are opposed to the source lines S. In particular, when the main common electrode CAL and main common electrode CAR are disposed immediately above the source line S1 and source line S2, respectively, the aperture region AP can be increased and the transmittance of the pixel PX can be improved, compared to the case in which the main common electrode CAL and main common electrode CAR are disposed on the pixel electrode PE side of the source line S1 and source line S2.

Furthermore, by disposing the main common electrode CAL and main common electrode CAR immediately above the source line S1 and source line S2, respectively, the inter-electrode distance between the pixel electrode PE, on one hand, and the main common electrode CAL and main common electrode CAR, on the other hand, can be increased, and a lateral electric field, which is closer to a horizontal lateral electric field, can be produced. Therefore, a wide viewing angle, which is the advantage of an IPS mode, etc. in the conventional structure, can be maintained.

According to the present embodiment, a plurality of domains can be formed in one pixel. Thus, the viewing angle can optically be compensated in plural directions, and a wide viewing angle can be realized.

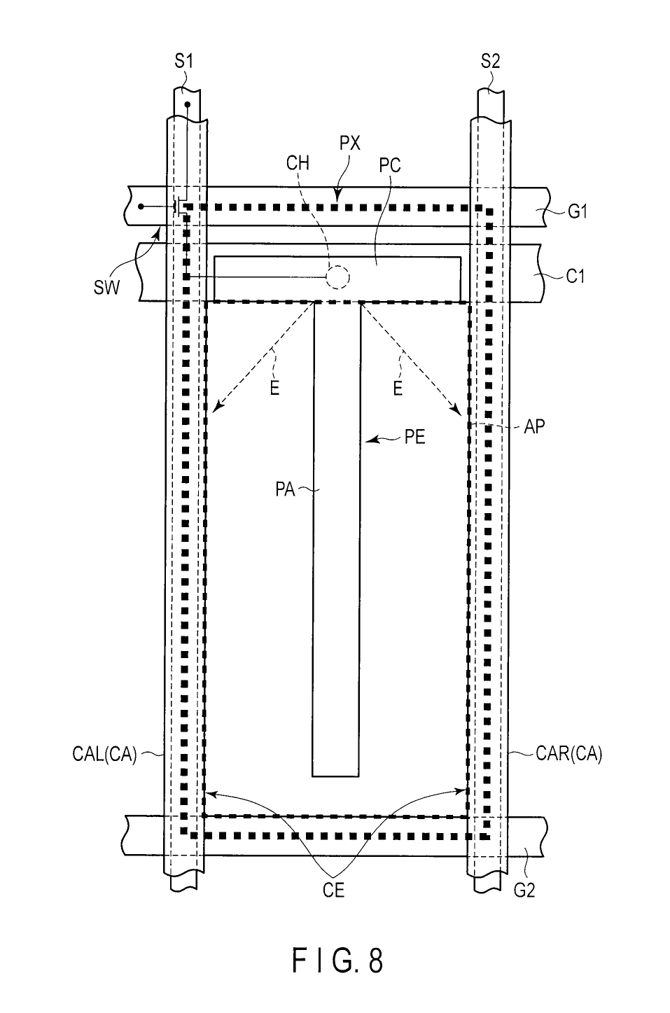

FIG. 8 is a plan view which schematically shows a structure example of one pixel at a time when the width of the main pixel electrode PA in the first direction X is made uniform, and the main pixel electrode PA is formed in a strip shape extending substantially linearly in the second direction Y.

Specifically, in this example illustrated, the liquid crystal display device is the same as that of the above-described embodiment, except that the main pixel electrode PA linearly extends in the second direction Y from the contact portion PC to the vicinity of the upper side end portion of the pixel PX and to the vicinity of the lower side end portion of the pixel PX.

In this case, if the vicinity of the contact portion PC and a region away from the contact portion PC are compared, an electric field, which is produced between the pixel electrode PE and the common electrode CE, is strong in the vicinity of the contact portion PC, and an electric field, which is produced between the pixel electrode PE and the common electrode CE, decreases gradually away from the contact portion PC. The cause of this appears to be that, in the vicinity of the contact portion PC, an electric field E occurs in an obliquely downward direction from a connection part between the contact portion PC and the main pixel electrode PA toward the main common electrode CA, but the influence of the electric field E gradually decreases away from the contact portion PC. In the meantime, the direction of the electric field E shown in FIG. 8 is a direction of the sum of an electric field component parallel to the first direction X and an electric field component parallel to the second direction Y, and no consideration is given to an electric field component parallel to the third direction Z.

Thus, when the main pixel electrode PA having the strip shape extending substantially linearly, as shown in FIG. 8, is formed, the electric field, which occurs between the main pixel electrode PA and the main common electrode CA, gradually decreases away from the contact portion PC in the second direction Y, and it is possible that the alignment of liquid crystal molecules LM does not easily restore to a predetermined state when the liquid crystal display panel is pressed. Due to a trace of such pressing being left, the display quality degrades.

By contrast, in the present embodiment, the main pixel electrode PA is formed such that the width in the first direction X gradually decreases away from the contact portion PC. In addition, each of both end portions of the main pixel electrode PA includes at least one step. In the example illustrated in FIG. 2, between the storage capacitance line C1 (or contact portion PC) and the gate line G2, three steps are provided on each of the left and right side end portions of the main pixel electrode PA. At such steps, since an end side extending in the first direction X is continuous with an end side extending in the second direction Y, an electric field E occurs in an obliquely downward direction from the main pixel electrode PA toward the main common electrode CA, like the vicinity of the connection part between the main pixel electrode PA and the contact portion PC. Thus, in the present embodiment, it is possible to suppress weakening of an electric field occurring between the main pixel electrode PA and the main common electrode CA at a part away from the contact portion PC. Even when the liquid crystal display panel has been pressed, the alignment of liquid crystal molecules is hardly disturbed, and a trace of pressing is not easily left. Thus, according to the present embodiment, a liquid crystal display device with good display quality can be provided.

In addition, the main pixel electrode PA includes at least one step at the central part of the aperture region AP in the second direction Y. Thereby, the intensity of the electric field occurring between the main pixel electrode PA and the main common electrode CA does not become non-uniform, and it becomes possible to more effectively avoid a trace of pressing being left.

The above-described example is directed to the case where the initial alignment direction of liquid crystal molecules LM is parallel to the second direction Y. However, the initial alignment direction of liquid crystal molecules LM may be an oblique direction D which obliquely crosses the second direction Y, as shown in FIG. 2. An angle θ1 formed between the second direction Y and the initial alignment direction D is 0° or more and 45° or less. From the standpoint of alignment control of liquid crystal molecules LM, it is very effective that the angle θ1 is about 5° to 30°, more preferably 20° or less. Specifically, it is desirable that the initial alignment direction of liquid crystal molecules LM be substantially parallel to a direction in a range of 0° to 20° relative to the second direction Y.

In particular, when the first alignment treatment direction PD1 or second alignment treatment direction PD2 is set to be parallel to the second direction Y that is the direction of extension of the main pixel electrode PA, a multi-domain is created with respect to the second direction Y and thus the viewing angle is improved. In addition, since the directions of rotation of liquid crystal molecules are uniquely determined along the electric field E in the entire region in the pixel, the occurrence of a dark line can be suppressed in the pixel, and the display quality can be enhanced. Furthermore, when the first alignment treatment direction PD1 and second alignment treatment direction PD2 are parallel and identical to each other and are set to be the direction in which the width of the main pixel electrode PA gradually decreases, that is, the direction from the side near the contact portion PC toward the side away from the contact portion PC, the above-described splay alignment occurs and thus the viewing angle is improved. In addition, since the directions of rotation of liquid crystal molecules are uniquely determined along the electric field E in the entire region in the pixel, the occurrence of a dark line can be suppressed in the pixel, and the display quality can be enhanced.

Besides, the above-described example relates to the case in which the liquid crystal layer LQ is composed of a liquid crystal material having a positive (positive-type) dielectric constant anisotropy. Alternatively, the liquid crystal layer LQ may be composed of a liquid crystal material having a negative (negative-type) dielectric constant anisotropy. Although a detailed description is omitted, in the case of the negative-type liquid crystal material, since the positive/negative state of dielectric constant anisotropy is reversed, it is desirable that the above-described formed angle θ1 be within the range of 45° to 90°, preferably the range of 70° or more.

Since a lateral electric field is hardly produced over the pixel electrode PE or common electrode CE even at the ON time (or an electric field enough to drive liquid crystal molecules LM is not produced), the liquid crystal molecules LM scarcely move from the initial alignment direction, like the case of the OFF time. Thus, even if the pixel electrode PE and common electrode CE are formed of a light-transmissive, electrically conductive material such as ITO, little backlight passes through these regions, and these regions hardly contribute to display at the ON time. Thus, the pixel electrode PE and common electrode CE do not necessarily need to be formed of a transparent, electrically conductive material, and may be formed of an electrically conductive material such as aluminum, silver, or copper.

In the present embodiment, the structure of the pixel PX is not limited to the example shown in FIG. 2.

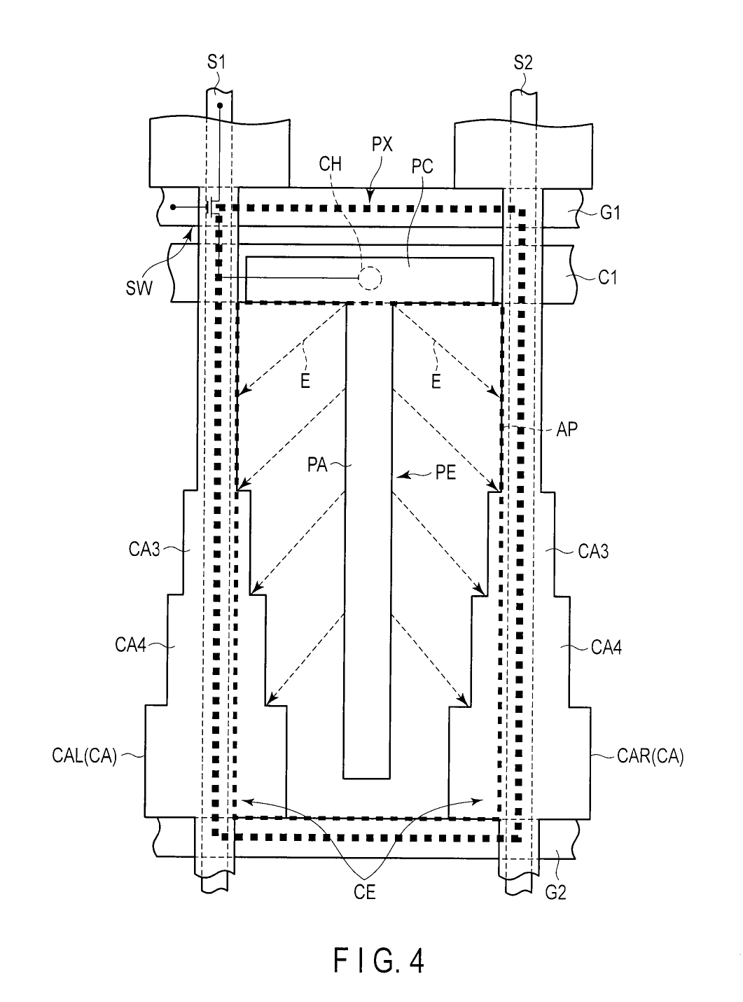

FIG. 4 is a plan view which schematically shows another structure example of one pixel at a time when the liquid crystal display panel LPN shown in FIG. 1 is viewed from the counter-substrate side.

This structure example differs from the structure example shown in FIG. 2 in that the main pixel electrode PA is formed in a strip shape having a uniform width in the first direction X and extending in the second direction Y, and that the width in the first direction X of the main common electrode CA increases stepwise along the second direction Y away from the contact portion PC.

Specifically, the main pixel electrode PA substantially linearly extends in the second direction Y from the contact portion PC to the vicinity of the lower side end portion of the pixel PX.

The width in the first direction X of the main common electrode CA is small at a portion thereof near the contact portion PC, and gradually increases away from the contact portion PC. In the example illustrated in FIG. 4, the width of the main common electrode CA in the first direction X varies stepwise. The shape of the main common electrode CA is line-symmetric with respect to an axis which is substantially parallel to the second direction Y. Each of both end portions in the first direction X of the main common electrode CA has at least one step. Specifically, the main common electrode CA includes two stepwise end sides. In the meantime, it is desirable that the main common electrode CA have at least one step at a central portion thereof in the second direction Y (or at a central portion of the aperture region AP). In addition, in the case where each of both end portions of the main common electrode CA includes a plurality of steps, it is desirable that these plural steps be arranged with predetermined distances along the second direction Y.

In other words, in a direction along the first direction X, the main common electrode CA has a smaller width at a portion thereof near the contact portion PC (or a portion at an intersection with the storage capacitance line C1) than at a portion thereof near an end portion of the main pixel electrode PA extending in the second direction Y (or a portion at an intersection with the gate line G2). In addition, the main common electrode CA includes a third portion CA3 located on a side near the contact portion PC and a fourth portion CA4 located on a side remoter from the contact portion PC in the second direction Y than the third portion CA3. In this case, when the width in the first direction X of the third portion CA3 is WC and the width in the first direction X of the fourth portion CA4 is WD, it should suffice if the width WC<the width WD. The width in the first direction X of the main common electrode CA may vary stepwise in the second direction Y, or may vary continuously in the second direction Y.

In the example illustrated in FIG. 4, between the storage capacitance line C1 (or contact portion PC) and the gate line G2, three steps are provided on each of the left and right side end portions of the main common electrode CA. At such steps, since an end side extending in the first direction X is continuous with an end side extending in the second direction Y, an electric field E occurs in an obliquely downward direction from the main pixel electrode PA toward the main common electrode CA, in the same manner as between the vicinity of the contact portion PC and the main common electrode CA. Thus, like the case shown in FIG. 2, it is possible to suppress weakening of an electric field occurring between the main pixel electrode PA and the main common electrode CA at a part away from the contact portion PC, and a trace of pressing is not left. Thus, also in the case of the structure of the pixel PX as illustrated in FIG. 4, the same advantageous effects as in the above-described embodiment can be obtained, and a liquid crystal display device with good display quality can be provided.

In addition, the main common electrode CA is provided with at least one step at the central part of the aperture region AP in the second direction Y. Thereby, the intensity of the electric field occurring between the main pixel electrode PA and the main common electrode CA does not become non-uniform, and it becomes possible to more effectively avoid a trace of pressing being left.

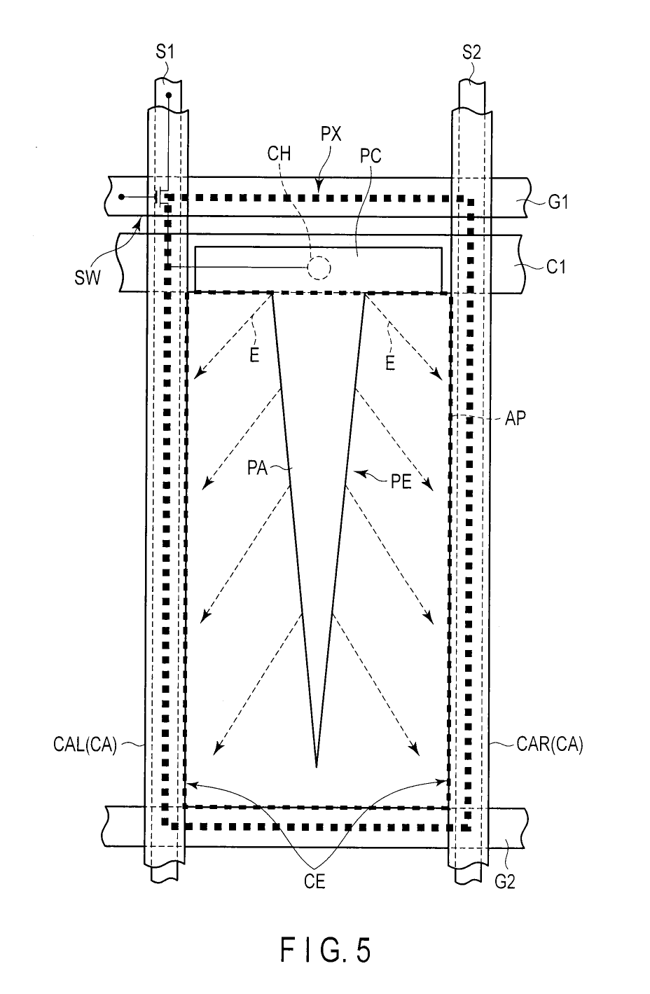

FIG. 5 is a plan view which schematically shows another structure example of one pixel at a time when the liquid crystal display panel LPN shown in FIG. 1 is viewed from the counter-substrate side.

This structure example differs from the structure example shown in FIG. 2 in that the width in the first direction X of the main pixel electrode PA varies continuously.

Specifically, the main pixel electrode PA extends in the second direction Y from the contact portion PC to the vicinity of the lower side end portion of the pixel PX. The width in the first direction X of the main pixel electrode PA is large at a portion thereof near the contact portion PC, and gradually decreases away from the contact portion PC. In this example, the width of the main pixel electrode PA decreases continuously away from the contact portion PC. The shape of the main pixel electrode PA is line-symmetric with respect to an axis which is substantially parallel to the second direction Y.

In other words, in a direction along the first direction X, the main pixel electrode PA has a larger width at a connection portion thereof with the contact portion PC, than at a distal end portion thereof extending in the second direction Y. In the example shown in FIG. 5, the main pixel electrode PA has a substantially isosceles-triangular shape. However, the main pixel electrode PA may have a shape which is surrounded by a parabolic end side projecting to the lower side (i.e. to the gate line G2 side) and an end side connected to the contact portion PC, or may be a substantially isosceles-trapezoidal shape.

If the main pixel electrode PA is formed as shown in FIG. 5, an electric field E in an obliquely downward direction from the main pixel electrode PA toward the main common electrode CA occurs uniformly between the main pixel electrode PA and the main common electrode CA. Thus, like the case shown in FIG. 2, it is possible to suppress weakening of an electric field occurring between the main pixel electrode PA and the main common electrode CA at a part away from the contact portion PC, and a trace of pressing is not left. Thus, also in the case of the structure of the pixel PX as illustrated in FIG. 5, the same advantageous effects as in the above-described embodiment can be obtained, and a liquid crystal display device with good display quality can be provided.

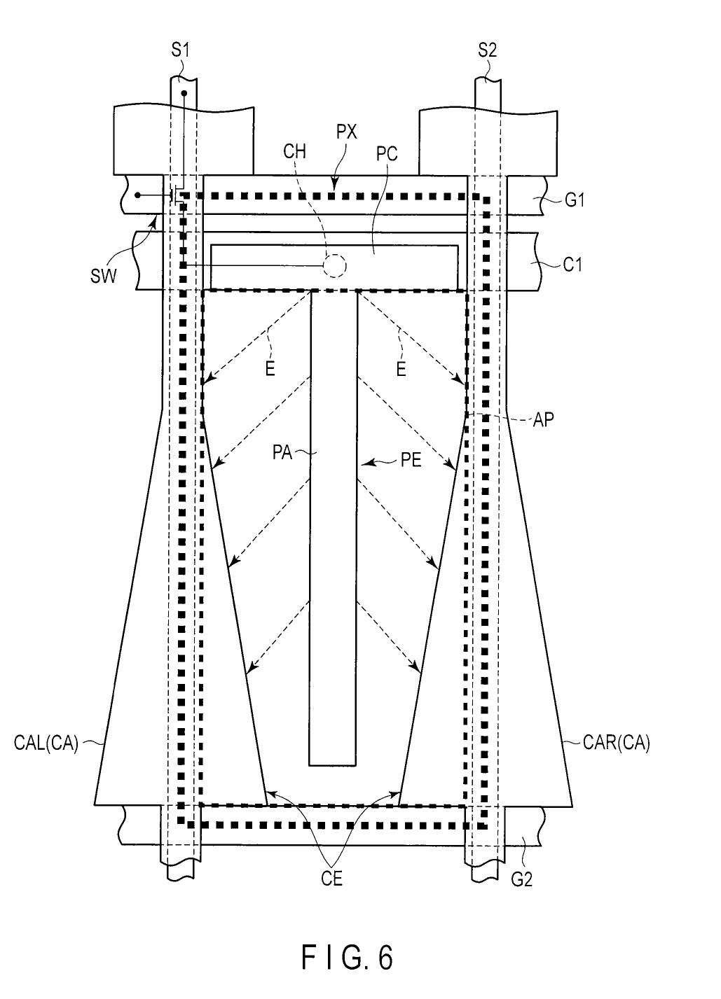

FIG. 6 is a plan view which schematically shows another structure example of one pixel at a time when the liquid crystal display panel LPN shown in FIG. 1 is viewed from the counter-substrate side.

This structure example differs from the structure example shown in FIG. 4 in that the width in the first direction X of the main common electrode CA varies continuously.

Specifically, the width in the first direction X of the main common electrode CA is small at a portion thereof near the contact portion PC, and gradually increases away from the contact portion PC. In this example, the width of the main common electrode CA in the first direction X increases continuously away from the contact portion PC. The shape of the main common electrode CA is line-symmetric with respect to an axis which is substantially parallel to the second direction Y.

If the main common electrode CA is formed as shown in FIG. 6, an electric field E in an obliquely downward direction from the main pixel electrode PA toward the main common electrode CA occurs uniformly between the main pixel electrode PA and the main common electrode CA along the second direction Y. Thus, like the case shown in FIG. 2, it is possible to suppress weakening of an electric field occurring between the main pixel electrode PA and the main common electrode CA at a part away from the contact portion PC, and a trace of pressing is not left. Thus, also in the case of the structure of the pixel PX as illustrated in FIG. 6, the same advantageous effects as in the above-described embodiment can be obtained, and a liquid crystal display device with good display quality can be provided.

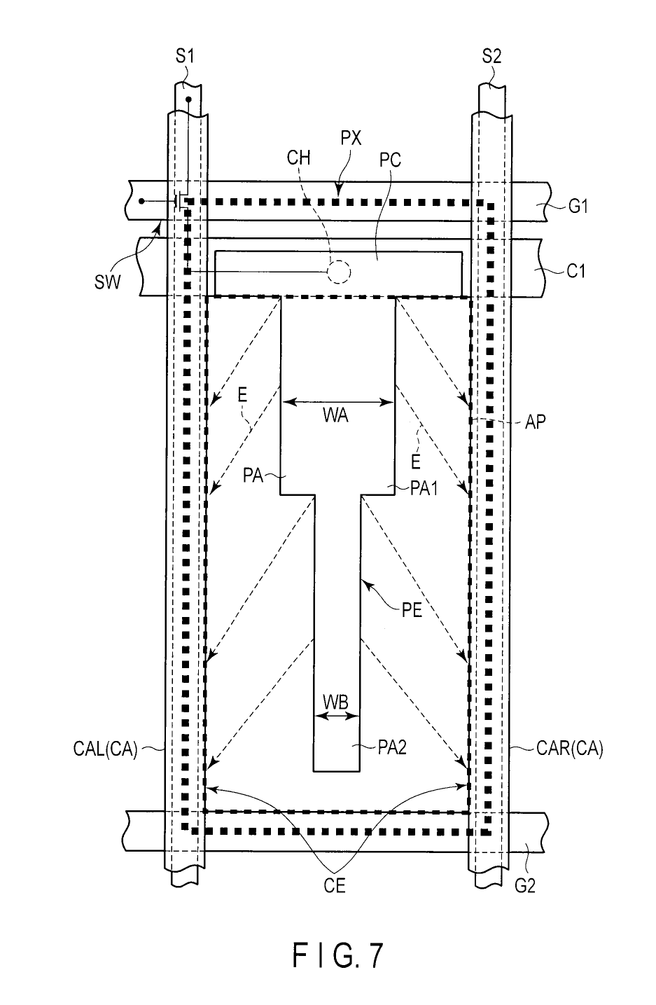

FIG. 7 is a plan view which schematically shows another structure example of one pixel at a time when the liquid crystal display panel LPN shown in FIG. 1 is viewed from the counter-substrate side.

This structure example differs from the structure example shown in FIG. 2 in that each of both end portions of the main pixel electrode PA has one step.

Specifically, the main pixel electrode PA extends in the second direction Y from the contact portion PC to the vicinity of the lower side end portion of the pixel PX. The main pixel electrode PA includes a first portion PA1 located on a side near the contact portion PC, and a second portion PA2 located on a side remote from the contact portion PC. The first portion PA1 has a uniform width WA. The second portion PA2 has a uniform width WB. The width WA is greater than the width WB. The shape of the main pixel electrode PA is line-symmetric with respect to an axis which is substantially parallel to the second direction Y.

Also in this structure example, the same advantageous effects as in the above-described embodiment can be obtained, and a liquid crystal display device with good display quality can be provided.

In the present embodiment, the common electrode CE may include, in addition to the main common electrodes CA, sub-common electrodes which extend in the first direction X. Specifically, the sub-common electrodes are arranged substantially in parallel, with an interval in the second direction Y, and extend in the first direction X, respectively. In addition, the sub-common electrodes are opposed to the gate lines. The pixel electrode PE is disposed between the sub-common electrodes.

If attention is paid to the positional relationship between the pixel electrode PE and common electrode CE, the main pixel electrode PA and main common electrodes CA are alternately arranged in the first direction X, and the contact portion PC and sub-common electrodes are alternately arranged in the second direction Y. In addition, one contact portion PC is located between the neighboring sub-common electrodes, and the sub-common electrode, contact portion PC and sub-common electrode are successively arranged in the named order in the second direction Y.

In this structure example, too, the liquid crystal molecules LM, which are initially aligned in the second direction Y at the OFF time, can form many domains in each pixel PX in the state in which an electric field is produced between the pixel electrode PE and common electrode CE at the ON time, and the viewing angle can be increased.

In the present embodiment, the common electrode CE may include, in addition to the main common electrodes CA provided on the counter-substrate CT, second main common electrodes which are provided on the array substrate AR and are opposed to the main common electrodes CA (or opposed to the source lines S). The second main common electrodes extend substantially in parallel to the main common electrodes CA and have the same potential as the main common electrodes CA. By providing such second main common electrodes, an undesired electric field from the source lines S can be shielded.

In addition, the common electrode CE may include second sub-common electrodes which are provided on the array substrate AR and are opposed to the gate lines G or auxiliary capacitance lines C. The second sub-common electrodes extend in a direction crossing the main common electrodes CA, and have the same potential as the main common electrodes CA. By providing such second sub-common electrodes, an undesired electric field from the gate lines G or storage capacitance lines C can be shielded. According to the structure including such second main common electrodes or second sub-common electrodes, degradation in display quality can further be suppressed.

As has been described above, according to the present embodiment, a liquid crystal display device, which can suppress degradation in display quality, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate including a pixel electrode including a contact portion and a main pixel electrode extending in a second direction from the contact portion;
a second substrate including main common electrodes extending in the second direction on both sides of the main pixel electrode; and
a liquid crystal layer including liquid crystal molecules held between the first substrate and the second substrate,
wherein a width of the contact portion in a first direction crossing the second direction is greater than a width of the main pixel electrode in the first direction, and
the main pixel electrode includes a first portion which is located on a side close to the contact portion and has a first width in the first direction, and a second portion which is located on a side remoter from the contact portion than the first portion in the second direction and has a second width in the first direction which is smaller than the first width.

2. The liquid crystal display device of claim 1, wherein the main pixel electrode is line-symmetric with respect to an axis which is substantially parallel to the second direction, and each of both end portions in the first direction of the main pixel electrode includes at least one step.

3. The liquid crystal display device of claim 2, wherein the first substrate further includes a first wiring extending in the first direction and a second wiring extending in the second direction, and
at least one said step is located at a central part in the second direction of the main pixel electrode.

4. The liquid crystal display device of claim 1, wherein the width in the first direction of the main pixel electrode varies continuously in the second direction.

5. The liquid crystal display device of claim 1, wherein the pixel electrode is disposed in a pixel having a less length in the first direction than in the second direction.

6. The liquid crystal display device of claim 3, wherein the second wiring is opposed to the main common electrode.

7. The liquid crystal display device of claim 1, wherein a first distance in the first direction between the first portion and the main common electrode is less than a second distance in the first direction between the second portion and the main common electrode.

8. A liquid crystal display device comprising:
a first substrate including a pixel electrode including a contact portion and a main pixel electrode extending in a second direction from the contact portion;
a second substrate including main common electrodes extending in the second direction on both sides of the main pixel electrode; and
a liquid crystal layer including liquid crystal molecules held between the first substrate and the second substrate,
wherein a width of the contact portion in a first direction crossing the second direction is greater than a width of the main pixel electrode in the first direction, and
the main common electrode includes a third portion which is located on a side close to the contact portion and has a third width in the first direction, and a fourth portion which is located on a side remoter from the contact portion than the third portion in the second direction and has a fourth width in the first direction which is greater than the third width.

9. The liquid crystal display device of claim 8, wherein the main common electrode is line-symmetric with respect to an axis which is substantially parallel to the second direction, and each of both end portions in the first direction of the main common electrode includes at least one step.

10. The liquid crystal display device of claim 9, wherein the first substrate further includes a first wiring extending in the first direction and a second wiring extending in the second direction, and
at least one said step is located at a central part in the second direction of the main common electrode.

11. The liquid crystal display device of claim 8, wherein the width in the first direction of the main common electrode varies continuously in the second direction.

12. The liquid crystal display device of claim 8, wherein the pixel electrode is disposed in a pixel having a less length in the first direction than in the second direction.

13. The liquid crystal display device of claim 10, wherein the second wiring is opposed to the main common electrode.

14. The liquid crystal display device of claim 8, wherein a third distance in the first direction between the third portion and the main pixel electrode is greater than a fourth distance in the first direction between the fourth portion and the main pixel electrode.
